(19) United States
(12) Patent Application Publication
(10) Pub. No.: US 2024/0413652 A1
(43) Pub. Date: Dec. 12, 2024

(54) TOTE POWER DOCK SYSTEM

(71) Applicant: Phononic, Inc., Durham, NC (US)

(72) Inventors: Karen Benedek, Winchester, MA (US); Michael Canaday, Durham, NC (US); Michael Hash, Raleigh, NC (US); Ed Karwacki, Garner, NC (US); James Poon, Durham, NC (US); Tim Violino, Durham, NC (US)

(21) Appl. No.: 18/741,592

(22) Filed: Jun. 12, 2024

Related U.S. Application Data
(60) Provisional application No. 63/507,504, filed on Jun. 12, 2023.

(51) Int. Cl. H02J 7/00; B60P 3/20; F25D 11/00

(52) U.S. Cl. CPC H02J 7/0044; B60P 3/205; F25D 11/003; H02J 7/0036; H02J 7/007188

(57) ABSTRACT

Systems and methods of a tote power dock system are provided. In some embodiments, a method of operating a power dock system includes: refraining from providing power to one or more electrical contacts of the power dock system when no actively cooled tote is present on the power dock system; determining that an actively cooled tote is present on the power dock system; and in response to determining that an actively cooled tote is present on the power dock system, providing power to the one or more electrical contacts of the power dock system. In some embodiments, this provides increased safety for the electrical connections.

### RELATED APPLICATIONS

This application claims the benefit of provisional patent application Ser. No. 63/507,504, filed Jun. 12, 2023, the disclosure of which is hereby incorporated herein by reference in its entirety.

### FIELD OF THE DISCLOSURE

The disclosure relates generally to temperature-controlled environments.

### BACKGROUND

Cold chain transport for food, drug or any products that need temperature control for delivery currently is done with tri temperature or refer trucks and vans upfitted with compressor based systems that cool or freeze the entire sectioned area of a truck and must be run constantly to maintain temperature inside the truck. Whether the truck has one gallon of milk or a pint of ice cream, the entire space must be cooled or frozen. Compressor based refer trucks and tri temp trucks or vans must be penetrated from the outside to get the cooling platform of a compressor-based system inside the truck or van, which voids the warranty of the van or truck. In addition, to run tri temperature trucks, dividers must exist between the temperature zones to maintain temperature. The separation of space requires separation of orders that have goods in two or more zones. Compressor based systems pull too much power for the system to be placed in or on a fully electric vehicle without degrading the range of the vehicle significantly. Improved systems and methods for thermal management are needed.

### SUMMARY

Systems and methods of a tote power dock system are provided. In some embodiments, a method of operating a power dock system includes: refraining from providing power to one or more electrical contacts of the power dock system when no actively cooled tote is present on the power dock system; determining that an Actively Cooled Tote (ACT) is present on the power dock system; and in response to determining that an ACT is present on the power dock system, providing power to the one or more electrical contacts of the power dock system. In some embodiments, this provides increased safety for the electrical connections.

An ACT requires application of electrical power when stationary in a storage or picking position, and removal of electrical power when tote is moved for transport. In some embodiments, power can be applied or removed automatically and safely, perhaps without direct manual action. In some embodiments, one or more of these functions are provided by a power dock system, perhaps assembled within a single, compact mechanical enclosure.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIGS. 1A-1D illustrate utilization of a portable, self-contained, refrigeration or freezing system, coupled with integrated automated controls and monitoring;

FIG. 2 and FIGS. 3A and 3B illustrate an example embodiment of an active cooler in accordance with embodiments of the present disclosure;

FIG. 4 illustrates a system including an active cooler in accordance with some embodiments of the present disclosure;

FIG. 5 illustrates an example of a tote as discussed herein;

FIGS. 6A and 6B illustrate that different versions of the totes could be used in refrigerator or freezer versions;

FIG. 7 shows an exploded view of the tote that includes a thermoelectric unit as discussed herein;

FIG. 8 shows the standard tri-temperature truck that is used for deliveries;

FIG. 9 illustrates a delivery truck which does not need refrigeration systems or needs less;

FIG. 10 illustrates an Actively Cooled Tote shown in two orientations, with electrical contacts on bottom, according to some embodiments;

FIG. 11 illustrates a vertical placement of Actively Cooled Tote onto Tote Dock, according to some embodiments; and

FIG. 12 illustrates an overall view of a tote dock, one contact shown in raised position, one contact shown in retracted position, according to some embodiments.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Last mile delivery of food requires temperature-controlled transport of perishable food items using transit vans or similar vehicles. For temperature control, refrigerated or freezer totes can be used which are installed in the van (e.g., a cargo van) or a box truck.

These totes use an active heat pump to pull heat from an enclosed chamber and reject it to surrounding ambient air. The hot air should be removed from the van to ensure optimum operation of the totes.

These totes require power while in transit maintain food safety requirements for perishable consumption. The electrical system needs to reach (and/or maintain) the correct temperature should be met for operation of the totes.

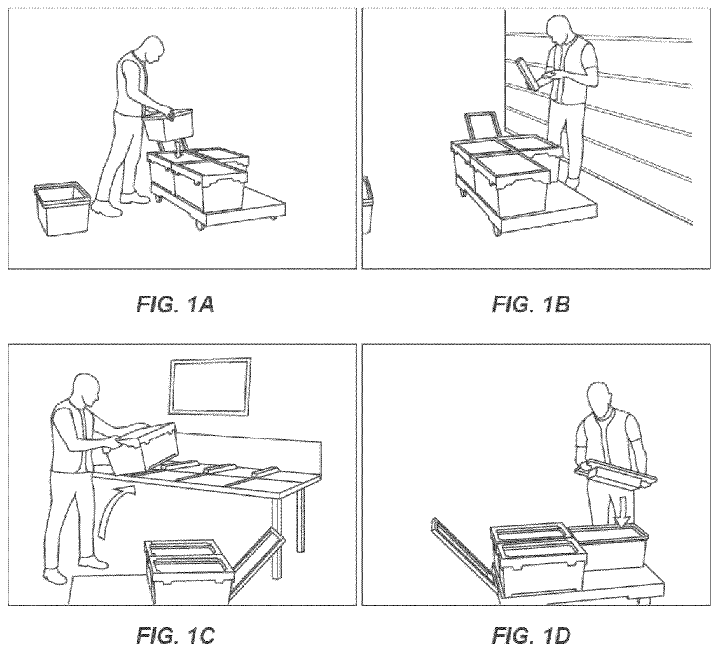

FIGS. 1A-1D illustrate utilization of a portable, self-contained, refrigeration or freezing system, coupled with integrated automated controls and monitoring.

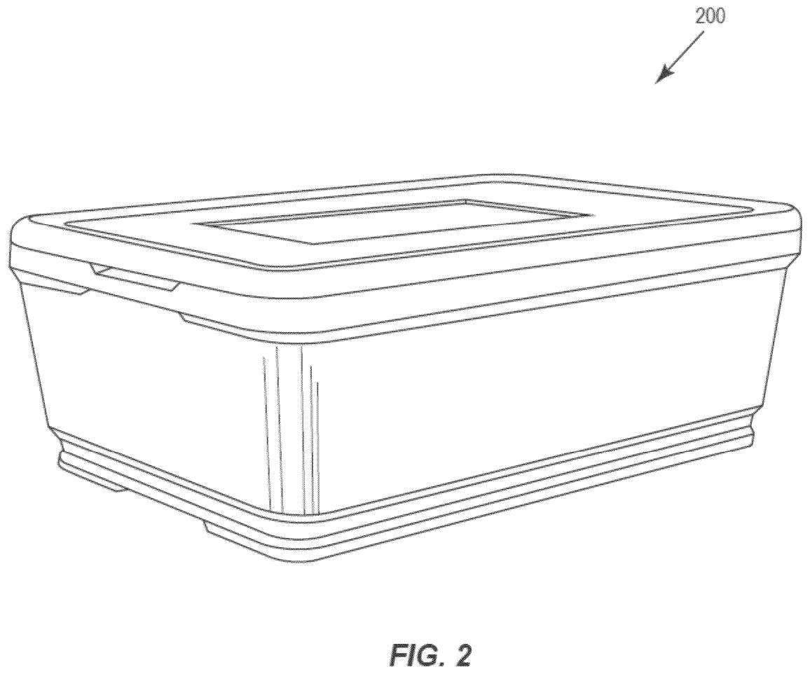

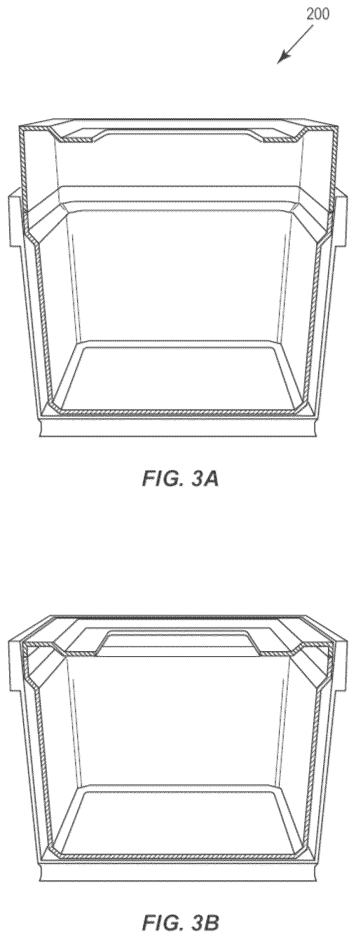

FIG. 2 and FIGS. 3A and 3B illustrate an example embodiment of an active cooler in accordance with embodiments of the present disclosure.

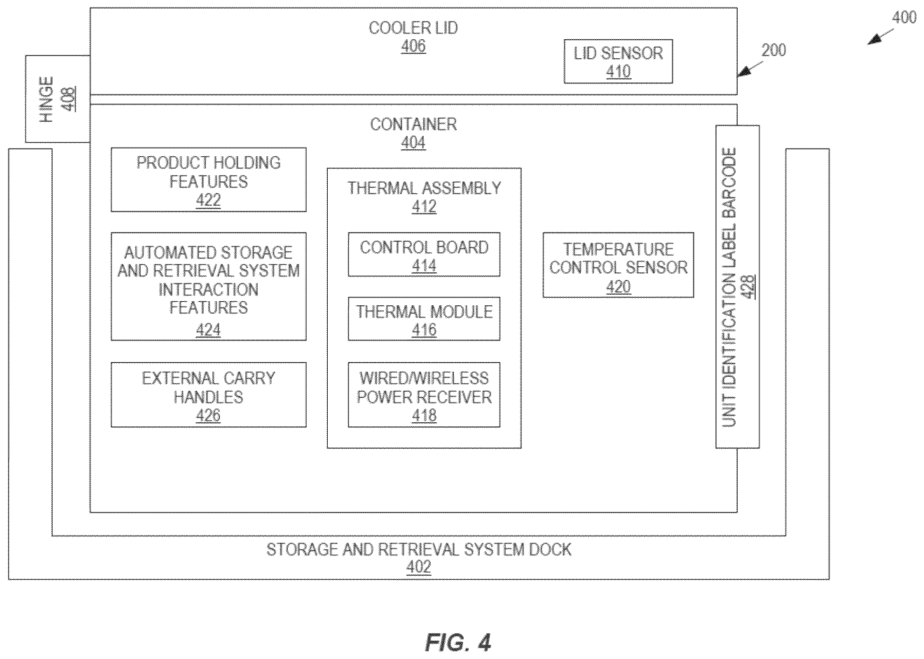

FIG. 4 illustrates a system including an active cooler in accordance with some embodiments of the present disclosure.

For more details, the interested reader is directed to U.S. Provisional Patent Application Ser. No. 62/953,771, entitled THERMOELECTRIC REFRIGERATED/FROZEN PRODUCT STORAGE AND TRANSPORTATION COOLER; U.S. patent application Ser. No. 17/135,420, entitled THERMOELECTRIC REFRIGERATED/FROZEN PRODUCT STORAGE AND TRANSPORTATION COOLER, now U.S. Patent Application Publication No. 2021/0199353 A1; and International Patent Application No. PCT/US2020/067172, entitled THERMOELECTRIC REFRIGERATED/FROZEN PRODUCT STORAGE AND TRANSPORTATION COOLER, now International Patent Publication No. WO 2021/134068. These applications are hereby incorporated herein by reference in their entirety.

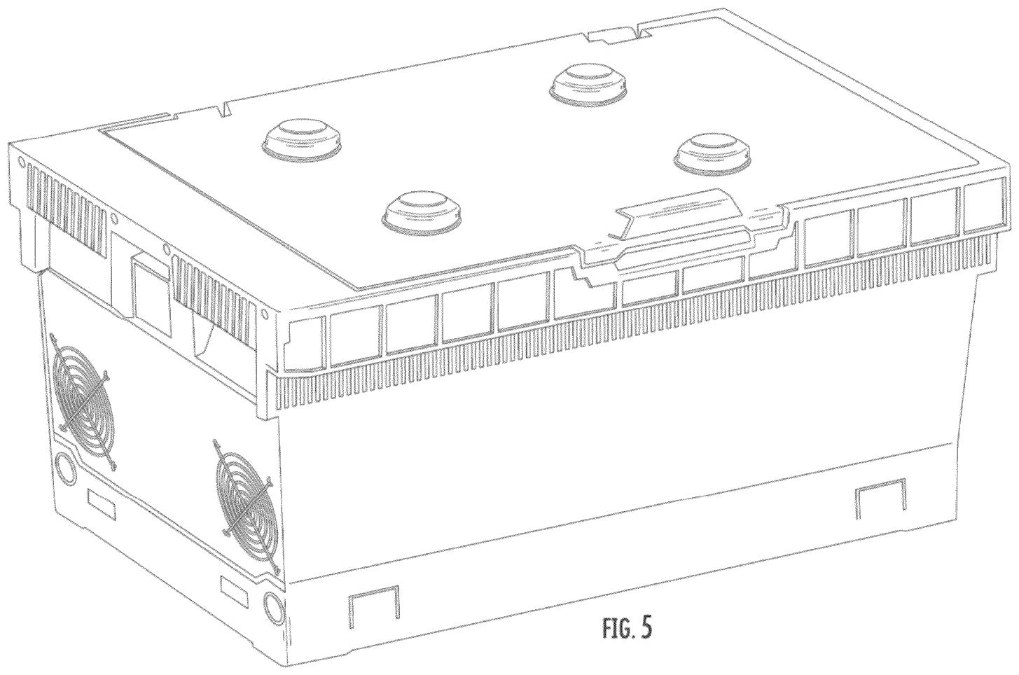

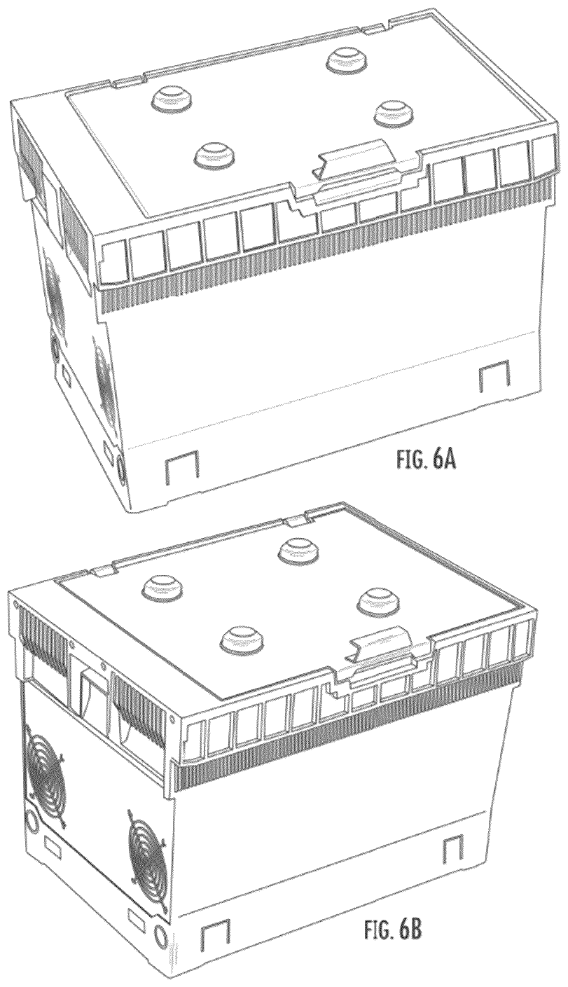

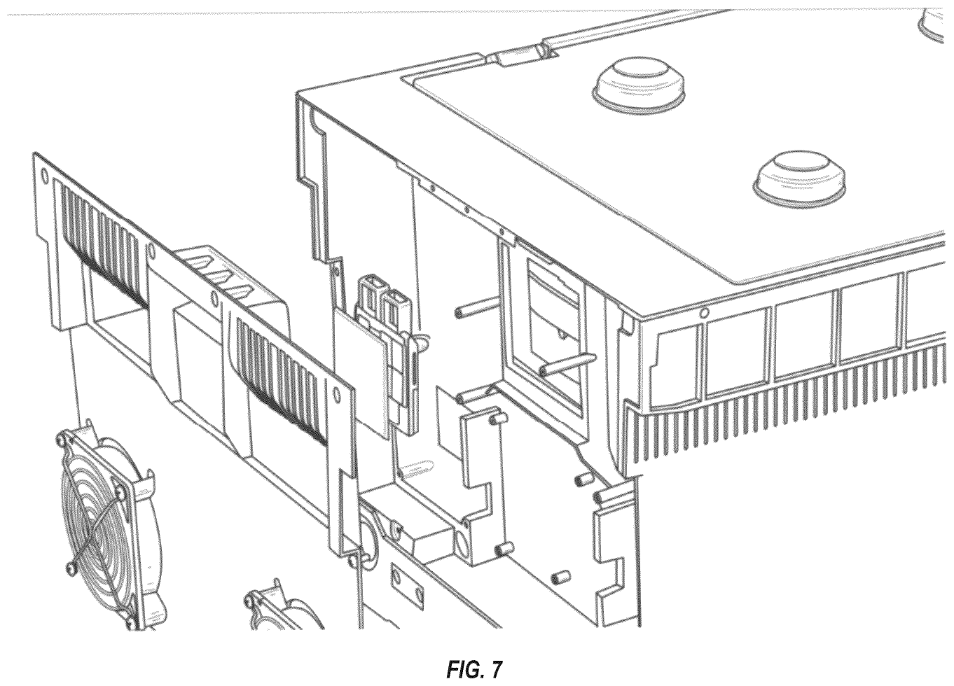

FIG. 5 illustrates an example of a tote as discussed herein. FIG. 6 illustrates that different versions of the totes could be used in refrigerator or freezer versions. FIG. 7 shows an exploded view of the tote that includes a thermoelectric unit as discussed herein.

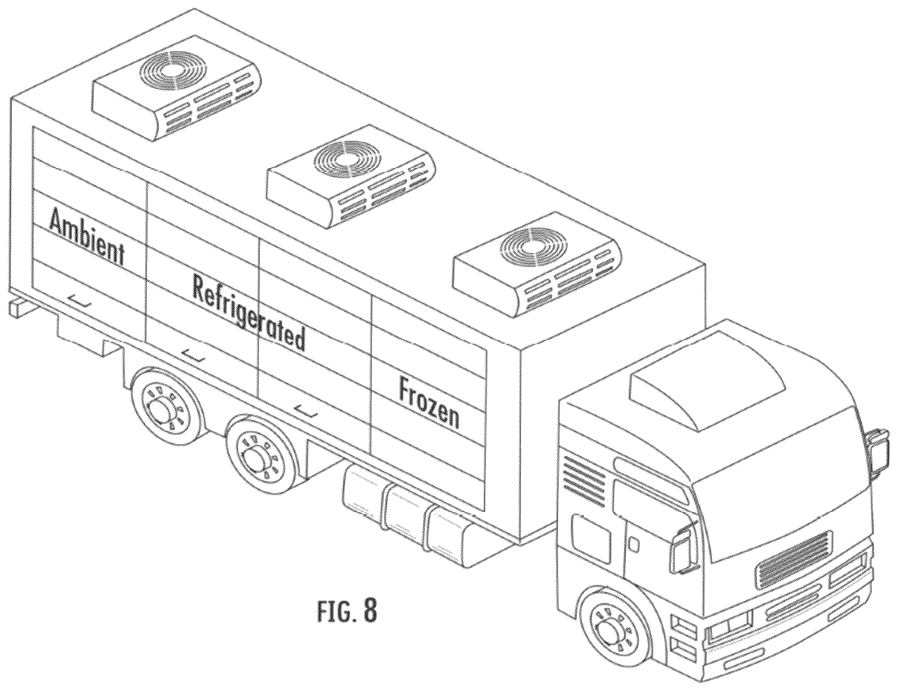

FIG. 8 shows the standard tri-temperature truck that is used for deliveries. This might include several different cooling systems that must be carried around regardless of whether they are currently needed.

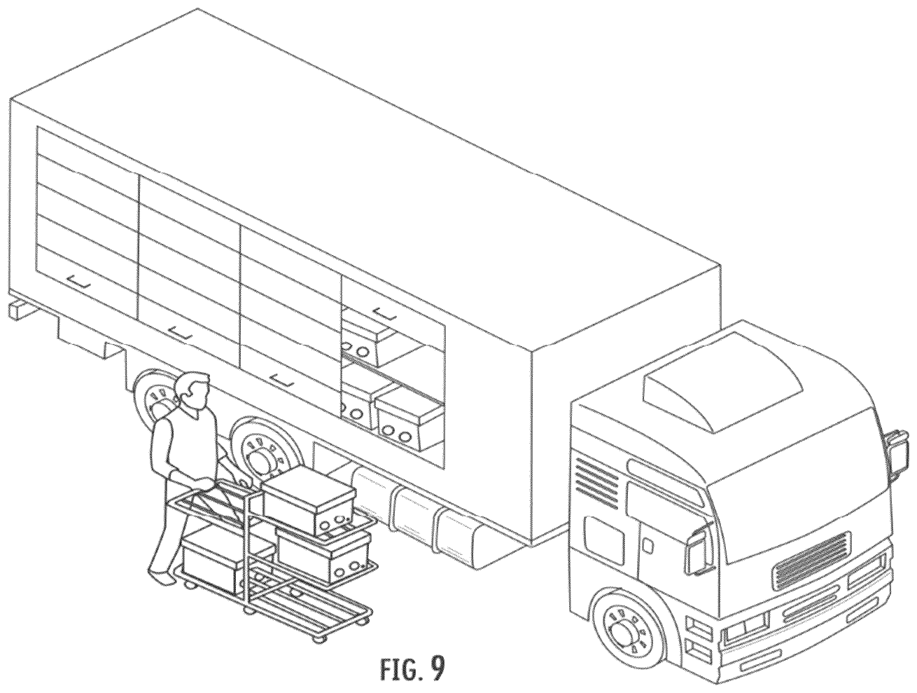

FIG. 9 illustrates a delivery truck which does not need refrigeration systems or needs less. In this embodiment, the totes provide the proper temperatures for the various goods. This can make the trucks more efficient in many ways. This also adds configurability. If an entire truck is needed for a specific temperature, this can be easily accomplished as opposed to the standard truck. These trucks might include charging capabilities or other amenities.

Systems and methods of a tote power dock system are provided. In some embodiments, a method of operating a power dock system includes: refraining from providing power to one or more electrical contacts of the power dock system when no actively cooled tote is present on the power dock system; determining that an Actively Cooled Tote (ACT) is present on the power dock system; and in response to determining that an ACT is present on the power dock system, providing power to the one or more electrical contacts of the power dock system. In some embodiments, this provides increased safety for the electrical connections.

An ACT requires application of electrical power when stationary in a storage or picking position, and removal of electrical power when tote is moved for transport. Power should be applied or removed automatically and safely without direct manual action. These functions are provided by a power dock system, assembled within a single, compact mechanical enclosure.

In some embodiments, some of these assumptions apply. Embodiments described herein implement some of these goals.

The application calls for no manual action required to turn power on or power off by an operator. Electrical contacts should not be energized when an ACT is not present to prevent accidental shorting. Electrical contacts should energize after an ACT is placed onto power dock to prevent arcing/sparking on approach.

Electrical contacts should de-energize prior to removal of an ACT to prevent arcing/sparking on departure. Electrical contacts should allow placement of ACT from multiple directions while ensuring proper polarity in each orientation.

Electrical contacts should not damage or degrade the ACT when the ACT slides across the contacts on way to final seating position. Dock assembly requires protection against damage by water ingress.

Dock assembly should be capable of installation in a variety of mechanical implementations. Internal PCB assembly may be adjusted in height to vary the sensitivity of proximity detection of the ACT.

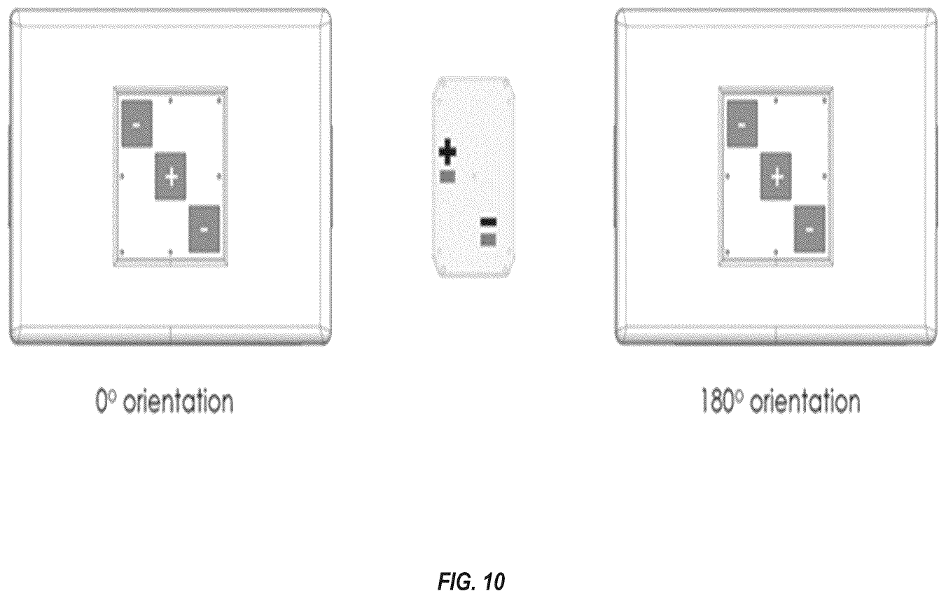

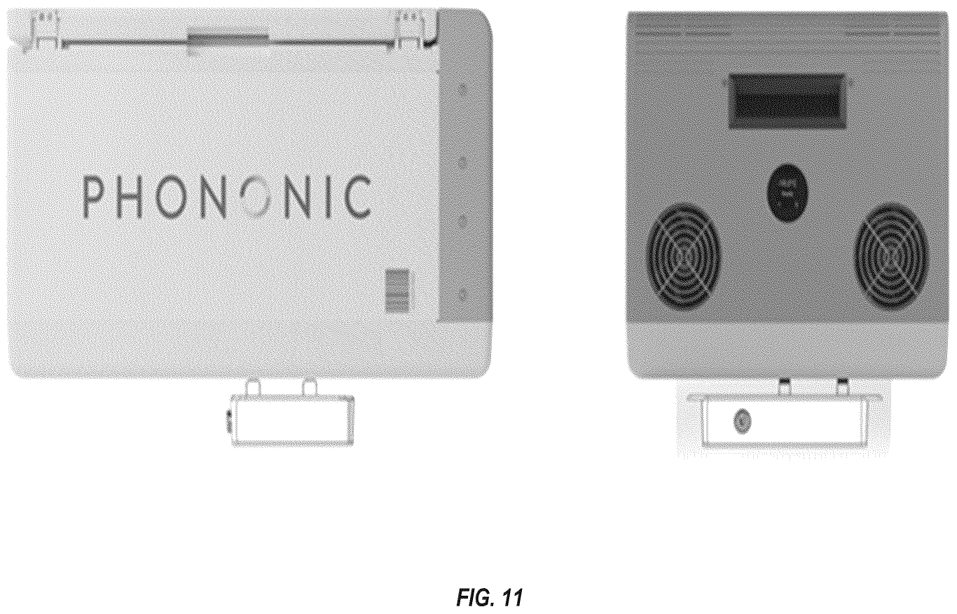

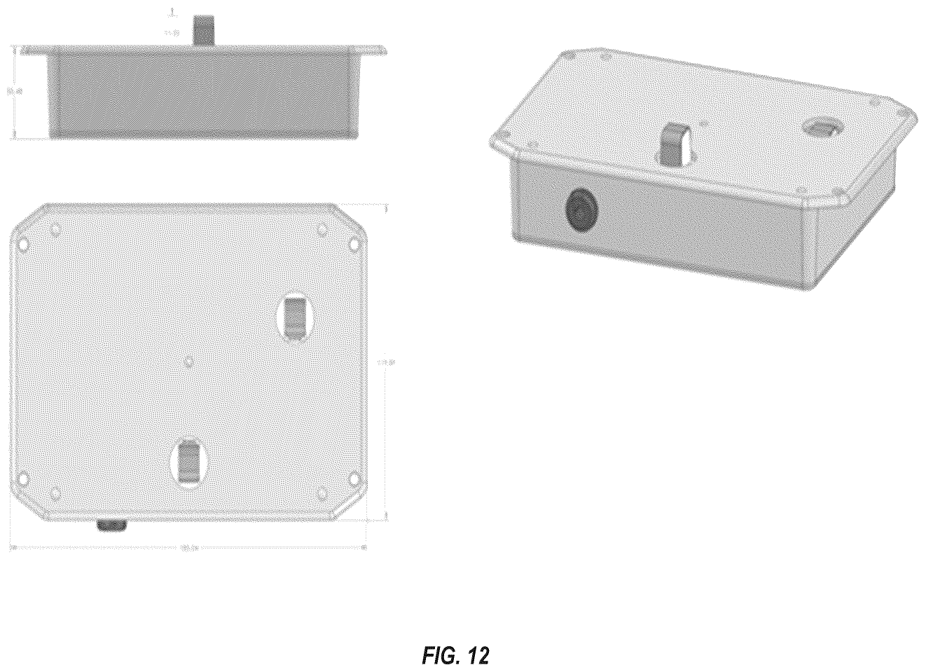

FIG. 10 illustrates an Actively Cooled Tote shown in two orientations, with electrical contacts on bottom. Correct polarity is maintained in either placement orientation, according to some embodiments. FIG. 11 illustrates a vertical placement of Actively Cooled Tote onto Tote Dock, according to some embodiments. FIG. 12 illustrates an overall view of a tote dock, one contact shown in raised position, one contact shown in retracted position, according to some embodiments.

In some embodiments, the tote dock provides DC electrical power to the Actively Cooled Tote when the ACT is placed onto the dock. Electrical contacts on the dock mate with contacts on the bottom of the ACT. Magnetic attraction is used to draw the dock contact to the tote contact. Gravity allows the dock contact to fall away from the tote when the steel plates behind the tote contacts are moved far enough from the dock contacts. A safety circuit in the tote dock includes a proximity sensor to distinguish an ACT from any other object and a timing circuit to delay the application of power for various safety reasons.

### Upon Tote Placement Onto Dock

The proximity sensor on the dock identifies that an ACT is within the placement range. This begins a time-delayed power application. Multiple embodiments of the proximity sensor are possible, including reed switch/magnet, microswitch, Hall-Effect sensor, optical switch/reader, or near-field communication (NFC) technology. Non-active totes or other objects will not have features present to cause this activation, ensuring activation only with placement of an Actively Cooled Tote. The internal PCB assembly holding the sensor may be adjusted in height to vary the sensitivity of proximity detection of the ACT. Additionally, the sensor/timer scheme prevents power application during “pass over” in a two-deep rack configuration where the back tote will pass over front contact position briefly on way to its back position.
1. The two contacts (+/−) of the dock rise-up to mate with the tote.
2. Power is applied to the mated contacts.

### Upon Tote Removal From Dock

1. The tote slides along or extends the contacts, maintaining power to the tote.
2. The tote leaves the activation range of the proximity sensor and power is disconnected from the contacts.
3. Upon breaking the magnetic mate to the tote contacts, the contacts of the tote dock are drawn down magnetically or fall down (e.g., by gravity) into the dock enclosure.

### Actuation of Dock Contacts

The copper contacts on the dock are placed over magnets so they will mate to the steel plates behind the tote's conductive contacts. The magnets provide a strong mating force between the pair of contacts, keeping contact resistance low. Spring-actuation was not chosen for this purpose—in such an embodiment, the dock contacts would push against the tote body, marring the tote body and depositing plastic residue on the tote dock contacts.

In some embodiments, the dock contacts have a 10 mm throw and a 5 mm active vertical range. The extra throw allows for electrical disengagement while the dock contacts are mated.

Prevention of the contacts binding up in the raised position aids in maintaining low mated contact resistance. Measures taken include:

In some embodiments, the contacts are magnetically retracted towards ferromagnetic rods when the steel plates in the tote's contact assembly are no longer present.

Wire routing and selection (many strands with flexible or no insulation) help to prevent the connections from holding the contacts up or pressing them against the guideposts.

In some embodiments, the design of the contact and surrounding structures prevents material from collecting under the contact and subsequent foreign object damage. To prevent damage from water ingress, internal channels are present to direct any collected water to designated drain holes.

In some embodiments, the electrical contacts in the dock are comprised of a plastic plug with an internal magnet, covered with an electrically conductive strip. The contact plug rides on a post that allows vertical movement while constraining movement in any other direction with minimal friction.

The posts that constrain the contact plugs are located on a tray that fits in the dock enclosure. In addition to locating the posts, the tray locates the safety control board. Features on the tray allow the safety control board to be adjusted in the vertical direction. The safety control board contains a proximity sensor. The height of the proximity sensor with respect to the location of the tote above the dock defines the operable area of the proximity sensor. Height control of the control board in the tray allows for tuning of the operation of the proximity sensor. This tuning is necessary to ensure that the power is off when the dock contacts disengage from the tote contacts. Making sure the power is off when the contacts engage or disengage reduces the risk of arcing or sparking as the tote is powered and depowered.

Those skilled in the art will recognize improvements and modifications to the preferred embodiments of the present disclosure. All such improvements and modifications are considered within the scope of the concepts disclosed herein.

What is claimed is:

1. A method of operating a power dock system, the method comprising:
refraining from providing power to one or more electrical contacts of the power dock system when no actively cooled tote is present on the power dock system;
determining that an actively cooled tote is present on the power dock system; and
in response to determining that an actively cooled tote is present on the power dock system, providing power to the one or more electrical contacts of the power dock system.

2. The method of claim 1 wherein determining that an actively cooled tote is present on the power dock system comprises: determining that a proximity sensor has detected that an actively cooled tote is present on the power dock system.

3. The method of claim 1 wherein the one or more electrical contacts of the power dock system mate with one or more contacts on a bottom of an actively cooled tote.

4. The method of claim 1 wherein magnetic attraction causes the one or more electrical contacts of the power dock system to be attracted to the one or more contacts on a bottom of an actively cooled tote.

5. The method of claim 1 further comprising:
if an actively cooled tote is removed, the one or more electrical contacts of the power dock system fall away from the one or more contacts on a bottom of an actively cooled tote faster than the actively cooled tote is removed.

6. The method of claim 1 further comprising:
upon detecting that an item is on the power dock system, determining if the item is an actively cooled tote.

7. The method of claim 6 further comprising:
upon determining that the item is an actively cooled tote, providing power to the one or more electrical contacts of the power dock system; and
upon determining that the item is not an actively cooled tote, refraining from providing power to the one or more electrical contacts of the power dock system.

8. The method of claim 6 further comprising:
upon determining that the item is an actively cooled tote, starting a time delayed application of power to the one or more electrical contacts of the power dock system.

9. The method of claim 1 further comprising:
if an actively cooled tote is on the power dock system, the one or more electrical contacts of the power dock system rise up to the one or more contacts on a bottom of an actively cooled.

10. The method of claim 2 wherein the proximity sensor comprises one of the group consisting of: a reed switch/magnet, a microswitch, a Hall-Effect sensor, an optical switch/reader, and a Near-Field Communication, NFC, technology.

11. A power dock system comprising:
one or more electrical contacts; and
a controller;
wherein the controller is configured to:
refrain from providing power to the one or more electrical contacts when no actively cooled tote is present on the power dock system;
determine that an actively cooled tote is present on the power dock system; and
in response to determining that an actively cooled tote is present on the power dock system, provide power to the one or more electrical contacts.

12. The power dock system of claim 11 wherein the power dock system further comprises a proximity sensor; and the controller being configured to determine that an actively cooled tote is present on the power dock system comprises being configured to: determine that the proximity sensor has detected that an actively cooled tote is present on the power dock system.

13. The power dock system of claim 11 wherein the one or more electrical contacts of the power dock system mate with one or more contacts on a bottom of an actively cooled tote.

14. The power dock system of claim 11 wherein magnetic attraction causes the one or more electrical contacts of the power dock system to be attracted to the one or more contacts on a bottom of an actively cooled tote.

15. The power dock system of claim 11 wherein:
if an actively cooled tote is removed, the one or more electrical contacts of the power dock system fall away from the one or more contacts on a bottom of an actively cooled tote faster than the actively cooled tote is removed.

16. The power dock system of claim 11 wherein the controller is further configured to:
upon detecting that an item is on the power dock system, determine if the item is an actively cooled tote.

17. The power dock system of claim 16 wherein the controller is further configured to:
upon determining that the item is an actively cooled tote, provide power to the one or more electrical contacts of the power dock system; and
upon determining that the item is not an actively cooled tote, refrain from providing power to the one or more electrical contacts of the power dock system.

18. The power dock system of claim 16 wherein the controller is further configured to:
upon determining that the item is an actively cooled tote, start a time delayed application of power to the one or more electrical contacts of the power dock system.

19. The power dock system of claim 11 wherein:
if an actively cooled tote is on the power dock system, the one or more electrical contacts of the power dock system rise up to the one or more contacts on a bottom of an actively cooled.

20. The power dock system of claim 12 wherein the proximity sensor comprises one of the group consisting of: a reed switch/magnet, a microswitch, a Hall-Effect sensor, an optical switch/reader, and a Near-Field Communication, NFC, technology.
